(19) United States
(12) Patent Application Publication
(10) Pub. No.: US 2006/0227251 A1
(43) Pub. Date: Oct. 12, 2006

(54) Television Remote Control with settable High/Low Volume Control Buttons

(75) Inventor: Stanley Anthony Dickervitz, North Providence, RI (US)

Correspondence Address: STANLEY A. DICKERVITZ, 45 PELHAM PKWY., NORTH PROVIDENCE, RI, 02911, US

(73) Assignee: Stanley Dickervitz, North Providence, RI (US)

(21) Appl. No.: 10/907,683

(22) Filed: Apr. 12, 2005

(51) Int. Cl. H04N 5/44

(52) U.S. Cl. 348/734

(57) ABSTRACT

A television remote with two settable volume level buttons. The “High” button could be selected for normal television listening sound level. The “Low” button could be selected for a lower listening sound level, an alternative to the mute sound button.

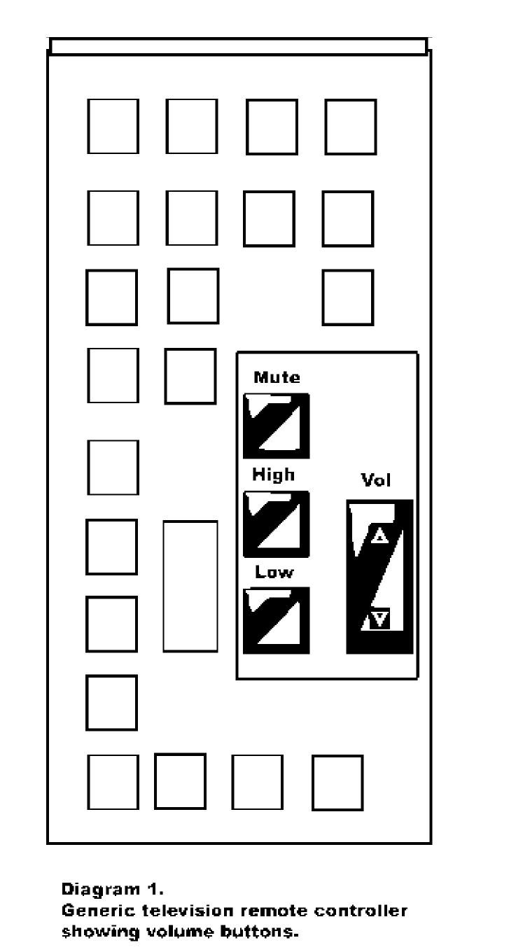

A television remote control having two settable volume control buttons in addition to the volume control and mute button. One button labeled “High” would be set using the volume control and the second button labeled “Low” would also be set using the volume control.

Pressing the “High” button would recall the higher level setting and pressing the “Low” button would recall the lower level setting.

What is claimed is:

1. Ability to select either of two preset volume levels on television remote controls.
